(19) United States
(12) Patent Application Publication
(10) Pub. No.: US 2021/0030215 A1
(43) Pub. Date: Feb. 4, 2021

(54) STORAGE DEVICE, MORE PARTICULARLY BATH- AND/OR SHOWER STORAGE DEVICE

(71) Applicant: Alexander KNOLL JUN., Gaildorf (DE)

(72) Inventor: Alexander KNOLL JUN., Gaildorf (DE)

(21) Appl. No.: 16/650,568

(22) PCT Filed: Sep. 27, 2018
(86) PCT No.: PCT/EP2018/076344

§ 371 Date: Mar. 25, 2020

(30) Foreign Application Priority Data
Sep. 28, 2017 (DE) 10 2017 122 598.6

(51) Int. Cl. A47K 3/28; A47B 96/02; H04L 29/08

(52) U.S. Cl. CPC A47K 3/281; A47B 96/02; A47B 2220/0097; A47B 2220/0077; H04L 67/125

(57) ABSTRACT

A storage device, in particular a bath and/or shower storage device, includes at least one storage element, at least one fastening unit for fastening the storage element on a wall, in particular a tiled room wall, at least one electronics unit at least partially arranged on the storage element, in particular an illumination unit and/or an entertainment electronics unit, and at least one inspection unit, which comprises at least one inspection element removably and/or movably mounted on a main body element of the fastening unit and/or on the storage element.

### PRIOR ART

The invention relates to a storage device, in particular a bath and/or shower storage device, having at least one storage element and having at least one fastening unit for fastening of the storage element on a wall, in particular on a tiled room wall.

A storage device, in particular a bath and/or shower storage device, having at least one storage element and having at least one fastening unit for fastening the storage element on a wall, in particular on a tiled room wall, is already known from DE 10 2012 015 574 A1.

Furthermore, storage devices having at least one storage element, having at least one fastening unit for fastening of the storage element on a wall, and having at least one electronics unit at least partially arranged on the storage element are respectively known from DE 20 2006 011 112 U1, DE 20 2012 104 121 U1, EP 2 710 194 B1, und CN 202 801 402 U.

The object of the invention is in particular to provide a device of the type in question having improved properties with respect to a user convenience. The object is achieved according to the invention by the features of claim 1, while advantageous embodiments and refinements of the invention can be inferred from the dependent claims.

### Advantages of the Invention

The invention is directed to a storage device, in particular a bath and/or shower storage device, having at least one storage element, having at least one fastening unit for fastening the storage element on a wall, in particular a tiled room wall, and having at least one electronics unit at least partially arranged on the storage element, in particular an illumination unit and/or an entertainment electronics unit.

It is proposed that the storage device comprise at least one inspection unit, which comprises at least one inspection element removably and/or movably mounted on a main body element of the fastening unit and/or on the storage element.

The electronics unit is preferably integrated at least partially, in particular at least in large part, into the storage device, in particular into the storage element. The storage element and/or a main body element of the fastening unit preferably comprises at least one receptacle recess for at least partially accommodating the electronics unit. The electronics unit is preferably arranged at least in large part in the receptacle recess. “Large part” is to be understood here in particular as more than 50%, preferably more than 70%, and particularly preferably more than 90% of a maximum total volume of an element and/or a unit. The electronics unit is preferably designed as an illumination unit and/or as an entertainment electronics unit. The electronics unit can be designed as an LED unit, as a loudspeaker unit, as a display unit, as an induction charging unit, as an electronic operating unit, as a projection unit, as a sensor unit, as an energy conversion unit, as a camera unit, as a microphone unit, and/or as another electronics unit which appears reasonable to a person skilled in the art.

The electronics unit, in particular if the electronics unit is embodied as an illumination unit, preferably comprises at least one illumination element, in particular at least one LED, which is arranged on the storage element and/or on the fastening unit. The illumination element is preferably arranged at least partially, in particular completely, in the receptacle recess. The electronics unit, in particular if the electronics unit is embodied as an illumination unit, particularly preferably comprises a plurality of illumination elements, in particular LEDs, which are arranged on the storage element and/or on the fastening unit, in particular are arranged in the receptacle recess. A control and/or regulating unit for control and/or regulation of the at least one illumination element, in particular of the illumination elements designed as LEDs, can be part of the electronics unit or can be formed separately from the electronics unit. The control and/or regulating unit, in particular if the control and/or regulating unit is embodied as part of the electronics unit, is preferably arranged on the storage element and/or on the fastening unit, in particular is arranged in the receptacle recess. However, it is also conceivable that the control and/or regulating unit, in particular if the control and/or regulating unit is embodied separately from the electronics unit, is arranged spaced apart from the storage element and/or the fastening unit, in particular the storage device, and is connected with respect to control and/or regulation to the electronics unit, in particular to the illumination elements designed as LEDs, by means of a communication connection, which is wired or wireless in particular.

The at least one illumination element, in particular the illumination elements, is/are preferably provided to introduce light into the storage element at least essentially along a direction extending at least essentially parallel to a storage surface of the storage element. The illumination element, in particular the illumination elements, preferably is/are arranged on the storage element in such a way that a main light emission direction of the illumination element, in particular the illumination elements, extends at least essentially in parallel to the storage surface of the storage element. The illumination element, in particular the illumination elements, preferably is/are arranged on a side wall surface of the storage element extending at least essentially perpendicular to the storage surface of the storage element. However, it is also conceivable that the illumination element, in particular the illumination elements, are arranged for an illumination of the storage element on a surface of the storage element extending at least essentially in parallel to the storage surface of the storage element, in particular in an alternative embodiment of the storage device, or are arranged on another surface, edge, or side of the storage element which appears reasonable to a person skilled in the art, in order to implement illumination of the storage element. “Essentially in parallel” is to be understood here in particular as an alignment of a direction in relation to a reference direction, in particular in a plane, wherein the direction has a deviation in relation to the reference direction in particular less than 8°, advantageously less than 5°, and particularly advantageously less than 2°. The expression “essentially perpendicular” is to define here in particular an alignment of a direction in relation to a reference direction, wherein the direction and the reference direction, in particular observed in a plane, enclose an angle of 90° and the angle has a maximum deviation of in particular less than 8°, advantageously less than 5°, and particularly advantageously less than 2°.

The storage element is preferably designed as a surface light element, in particular as a surface light element which can be peripherally illuminated. The storage element is preferably designed as an acrylic glass plate, as a glass plate, or the like. The storage element preferably comprises a lacquer layer on at least one side, in particular for a reflection of the light emitted by means of the illumination element/illumination elements.

The storage element can comprise a light scattering lacquer. However, it is also conceivable that the storage element comprises another embodiment which appears reasonable to a person skilled in the art and which enables a surface illumination by way of peripherally arranged illumination elements. The storage device preferably comprises at least one scattering and/or bundling element, for example, a laser grid element, a reflector element, or the like, which is arranged on the storage element or is formed integrally with the storage element. “Integrally” is to be understood in particular as at least materially bonded, for example, by a welding process, an adhesive bonding process, an injection process, and/or another process which appears reasonable to a person skilled in the art, and/or advantageously molded in one piece, for example, by a production from a cast and/or by a production in a single-component or multicomponent injection molding method and advantageously from a single blank.

The fastening unit is preferably formed from a metallic material, in particular stainless steel. However, it is also conceivable that the fastening unit is formed from another material which appears reasonable to a person skilled in the art, for example, plastic or the like. The fastening unit preferably comprises at least the main body element, on which the storage element at least partially abuts, in particular directly abuts. The main body element preferably comprises at least one contact surface, on which the storage element abuts in a state of the storage element arranged on the main body element, in particular with a surface of the storage element facing away from the storage surface of the storage element. The contact surface of the main body element preferably extends at least essentially in parallel to the storage surface of the storage element in a state of the storage element arranged on the main body element. The storage element is preferably fixed on the fastening unit, in particular the main body element, by means of a formfitting, friction-locked, and/or materially-bonded connection. The fastening unit preferably comprises at least one wall fastening element for fastening of the fastening unit on a wall, in particular a tiled room wall. The wall fastening element preferably comprises at least one wall contact surface, by means of which the wall fastening element can be arranged on the wall, in particular on a raw wall, which is preferably untiled. The wall contact surface is preferably provided to be fastened by means of a tile adhesive and/or a fastening element, for example, by means of a screw, by means of a nail, or the like on the wall, in particular on the raw wall. However, it is also conceivable that the wall contact surface is provided to be fastened by means of a fastening element, for example, by means of a screw, by means of a nail, or the like on a wall already provided with a wall covering, for example, one or more tiles. In particular, the wall fastening element comprises at least one recess for accommodating the tile adhesive and/or the fastening element. The wall fastening element preferably comprises at least one wall covering contact surface for a contact on a wall covering, in particular a tile. The wall covering, in particular the tiles, is preferably fixable by means of a tile adhesive on the wall covering contact surface. The wall covering contact surface is preferably arranged on a side of the wall fastening element facing away from the wall contact surface, in particular on a side of the wall fastening element facing toward the storage element. The receptacle of the wall fastening element preferably extends proceeding from the wall covering contact surface up to the wall contact surface. The wall fastening element preferably extends in a plane which runs at least essentially perpendicular to a main extension plane of the main body element. The main extension plane of the main body element preferably runs at least essentially parallel to the storage surface of the storage element in a state of the storage element arranged on the main body element. “Provided” is to be understood in particular as specially programmed, designed, and/or equipped. An object being provided for a specific function is to be understood in particular to mean that the object fulfills and/or executes this specific function in at least one application state and/or operating state. The fastening unit preferably comprises at least two wall fastening elements. The at least two wall fastening elements preferably have an at least essentially similar embodiment. However, it is also conceivable that the fastening unit comprises a number of wall fastening elements differing from two. The wall fastening element/elements and the main body element are preferably integrally formed with one another.

The fastening unit preferably comprises a peripheral web. The peripheral web preferably extends in a plane which runs at least essentially perpendicular to the main extension plane of the main body element. The peripheral web is preferably provided to cover at least one side of the storage element at least to an extent of more than 30%, preferably more than 60%, particularly preferably more than 90%, and very particularly preferably completely, in particular in a state of the storage element arranged on the fastening unit. The peripheral web is preferably formed integrally with the wall fastening element/elements and the main body element.

The inspection element is preferably mounted translationally and/or pivotably on the main body element and/or on the storage element. The inspection unit preferably comprises a movement axis, around and/or along which the inspection element is movably mounted in relation to the main body element and/or the storage element. The movement axis of the inspection unit preferably runs at least essentially in parallel to the storage surface of the storage element and/or the main extension plane of the main body element. However, it is also conceivable that the movement axis extends along another surface and/or plane of the storage element and/or the main body element which appears reasonable to a person skilled in the art. The inspection element is preferably provided to overlap, in particular to close, the receptacle recess. The inspection element is preferably designed as an inspection flap, an inspection lid, an inspection cover, or the like. The inspection unit preferably comprises at least one, in particular movably mounted, fixing element for securing the inspection element against a movement in relation to the storage element and/or the main body element. The fixing element is preferably designed as a closure. The fixing element can be designed as a movably mounted rotating lever, as a knee joint closure, as a screw, as a catch closure, or as another closure which appears reasonable to a person skilled in the art. The inspection element can be arranged on a side of the storage element facing away from the main body element, on a side of the main body element facing away from the storage element, on a side of the storage element and/or the main body element transverse to the storage surface of the storage element and/or to the main extension plane of the main body element or another side which appears reasonable to a person skilled in the art.

With the aid of the embodiment according to the invention of the storage device, a conveniently operable entry/access to the electronics unit can advantageously be implemented, in particular for maintenance and/or repair of the electronics unit. A receptacle recess, in which the electronics unit is arranged, can advantageously be securely closed. A high level of user convenience can advantageously be achieved. An at least essentially simultaneous arrangement of the electronics unit and the storage device on a wall, in particular a room wall, can advantageously be implemented. Installation costs and/or installation time can advantageously be saved, in particular in comparison to a separate installation of a storage device and an electronics unit fixable thereon. A securely designed and simple integration of an electronics unit into the storage device can advantageously be enabled. Indirect illumination can be implemented with a simple design, in particular in a bathroom. An entertainment electronics unit can advantageously be arranged securely on the storage device with a simple design.

Furthermore, it is proposed that the storage device comprise at least one seal unit, which is provided to arrange the inspection element in a sealed manner on the main body element and/or on the storage element, in particular according to a protection class greater than IP51 according to DIN EN 60529, preferably greater than IP61 according to DIN EN 60529, and particularly preferably greater than IP65 according to DIN EN 60529. The seal unit is very particularly preferably provided to arrange the inspection element in a sealed manner on the main body element and/or on the storage element according to a protection class IP68 according to DIN EN 60529. The seal unit preferably comprises at least one seal element arranged on the main body element and/or on the storage element. The seal element is preferably arranged between the inspection element and the main body element and/or the storage element. The seal element can be designed as a paper seal, a rubber seal, a plastic seal, or the like. The seal element preferably at least partially, in particular completely encloses the receptacle recess. The seal element preferably abuts the main body element and/or the storage element with at least one seal surface. The seal element preferably abuts the inspection element with at least one further seal surface, in particular in a closed state of the inspection element. A more secure protection of the electronics unit can advantageously be achieved by means of the embodiment according to the invention. A more secure protection in particular against a penetration of dust and/or moisture into the receptacle recess can advantageously be implemented. A high level of user convenience can advantageously be achieved, in particular since the storage device can be arranged conveniently and securely in a bathroom, in particular in a wet room.

Moreover, it is proposed that the storage device comprise at least one, in particular wireless communication unit, which is provided to exchange electronic data with an external unit, which are processable by the electronics unit and/or are provided for control and/or regulation of the electronics unit. The communication unit can be designed as a Bluetooth unit, an NFC unit, an infrared unit, a radio unit, in particular as a WLAN unit, and/or as another, in particular wireless communication unit which appears reasonable to a person skilled in the art. It is also conceivable that the communication unit is alternatively or additionally designed as a wired communication unit. The external unit can be designed as a remote control, in particular for control and/or regulation of the electronics unit, for example, for control and/or regulation of a color of the electronics unit designed as an illumination unit, for control and/or regulation of a brightness of the electronics unit designed as an illumination unit, for control and/or regulation of a volume of the electronics unit designed as an entertainment electronics unit, for an intensity of a display of the electronics unit designed as an entertainment electronics unit, for control and/or regulation of a temperature of the electronics unit designed as a thermostat unit, or the like. It is also conceivable that the external unit is designed as a mobile processing and/or communication device, in particular as a smart phone, a tablet, a laptop, or the like, which can exchange electronic data with the communication unit, which are processable by the electronics unit and/or are provided for a control and/or regulation of the electronics unit. A convenient transfer of electronic data for processing by the electronics unit and/or for control and/or regulation of the electronics unit can advantageously be implemented by means of the embodiment according to the invention. A high level of user convenience can advantageously be achieved.

Furthermore, it is proposed that the electronics unit comprise at least one, in particular acoustic and/or optical input and/or output element, which is arranged on the main body element and/or on the storage element, wherein the input and/or output element can be controlled and/or regulated in dependence on electronic data transferred by means of the communication unit. The input and/or output element can be designed as a loudspeaker, a display, a touch display, or the like. The input and/or output element, if it is embodied as a display, is preferably at least partially integrated into the storage element, in particular as an OLED film display or the like. The input and/or output element, if it is embodied as a display, is preferably at least partially integrated into the storage surface of the storage element. However, it is also conceivable that the input and/or output element is at least partially integrated into the fastening unit. An entertainment and/or information transmission to a user can advantageously be implemented by means of the embodiment according to the invention, in particular an advantageous entertainment and/or information option for a user can be implemented if the storage device is arranged in a wet room. A high level of user convenience can advantageously be achieved.

Furthermore, it is proposed that the electronics unit comprise at least one, in particular acoustic and/or optical input and/or output element, which is movably mounted on the main body element and/or on the storage element. The input and/or output element, in particular if it is embodied as a display, is preferably movably mounted, in particular translationally and/or pivotably, on the main body element and/or on the storage element.

The input and/or output element, if it is embodied as a display, is preferably movably mounted translationally and/or pivotably along and/or around a movement axis of the storage element, which runs at least essentially in parallel to the storage surface of the storage element and/or to the main extension plane of the main body element. The input and/or output element can be arranged, in particular movably mounted, on a side of the storage element facing away from the main body element, on a side of the main body element facing away from the storage element, on a side of the storage element and/or the main body element transverse to the storage surface of the storage element and/or to the main extension plane of the main body element or on another side which appears reasonable to a person skilled in the art. A compact embodiment of the storage device can advantageously be implemented by means of the embodiment according to the invention. A position of the input and/or output element is preferably continuously settable in relation to the storage element and/or the main body element. A movement of the input and/or output element into a position most reasonable for a user can advantageously be implemented. A high level of user convenience can advantageously be achieved.

Moreover, it is proposed that the storage device comprise at least one energy conversion unit, in particular an energy harvesting unit, which is provided to convert mechanical energy and/or thermal energy into electrical energy for operation of the electronics unit. The energy conversion unit is preferably provided to convert movement energy and/or radiant energy, for example, light radiation, into electric energy. The energy conversion unit preferably comprises at least one piezo element, in particular a piezo grid, and/or a solar element. The energy conversion unit is preferably provided to convert mechanical and/or thermal energy of water drops incident on the energy conversion unit, of a water jet incident on the energy conversion unit, and/or of light radiation incident on the energy conversion unit, in particular if the storage device is arranged in a wet room, for example, a shower stall, into electrical energy for operation of the electronics unit. The energy conversion unit is preferably electrically connected to an energy storage unit, in particular an accumulator, of the storage device. An environmentally-protective operation of the electronics unit can advantageously be implemented by means of the embodiment according to the invention. A high level of user convenience can advantageously be achieved.

Furthermore, it is proposed that the electronics unit comprise at least one, in particular touch-sensitive operating element, which is arranged on the main body element and/or on the storage element, for inputting operating commands. The operating element can be at least partially integrally formed with the input and/or output element, in particular if the input and/or output element is embodied as a touch-sensitive display. However, it is also conceivable that the operating element is formed separately from the input and/or output element. For example, it is conceivable that the operating element is arranged on the inspection element, in particular as a touch-sensitive operating element, for example, as a touch sensor or the like. The operating element is preferably provided for inputting an operating command for control and/or regulation of the electronics unit, for example, for a selection of a color of the electronics unit designed as an illumination unit, for setting a brightness of the electronics unit designed as an illumination unit, for setting a volume of the electronics unit designed as an entertainment electronics unit, for a selection of a program, in particular of a radio and/or television broadcaster, of the electronics unit designed as an entertainment electronics unit, or the like. The electronics unit can comprise a plurality of, in particular touch-sensitive operating elements, which are provided for inputting an operating command and are arranged on the main body element and/or on the storage element. A convenient operation of the electronics unit can advantageously be implemented by means of the embodiment according to the invention. A high level of user convenience can advantageously be achieved.

Furthermore, it is proposed that the electronics unit comprises at least one, in particular wired energy and/or communication interface for transfer of electrical energy and/or electronic data. The in particular wired energy and/or communication interface can be designed, for example, as a USB interface or the like, for connection to a mobile storage and/or communication device, in particular a smart phone, a tablet, a laptop, a USB stick, or the like. The seal unit preferably comprises at least one closure element, which is provided to close the energy and/or communication interface in a sealed manner. A convenient data exchange for operation of the electronics unit can advantageously be implemented by means of the embodiment according to the invention. A high level of user convenience can advantageously be achieved.

Moreover, it is proposed that the electronics unit comprise at least one induction unit, which is provided for inductive transfer of electrical energy. The induction unit is preferably arranged on the storage element, in particular in close range to the storage surface of the storage element, and/or on the main body element. The induction unit preferably comprises at least one induction coil element, which is provided for wireless transfer of electrical energy. By means of the embodiment according to the invention, convenient charging of a mobile battery-operated device and/or heating of an external unit, for example, a coffee cup, a baby bottle, a food intake unit, or the like can advantageously be implemented. A high level of user convenience can advantageously be achieved.

Furthermore, it is proposed that the electronics unit comprise at least one projection unit, which is provided to project items of information on an object spaced apart from the projection unit, in particular a room wall or a water jet. The projection unit is preferably arranged on the storage element and/or on the main body element. At least one output lens element of the projection unit is preferably arranged in an outer side of the storage element and/or the main body element, in particular to enable an emission of a projection beam, in particular a light beam and/or laser beam. By means of the embodiment according to the invention, a projection of items of information, for example, a time of day, a video, an image, or the like can advantageously be implemented on a room wall and/or a water jet. A high level of user convenience can advantageously be achieved, in particular by a convenient and well visible output of items of information by means of the projection unit.

Furthermore, it is proposed that the electronics unit comprise at least one thermostat element for regulating a temperature of a water jet and/or a room temperature, in particular as a result of a wireless transfer of electronic data to an external heating device. However, it is also conceivable that the electronics unit is connected in a wired manner to the heating device, in particular for regulating a temperature of a water jet and/or a room temperature by means of the thermostat element. A desired temperature can preferably be input by a user by means of the operating element of the electronics unit. However, it is also conceivable that the electronics unit comprises a speech input element designed as a microphone for inputting operating commands, in particular for implementing a speech controller of the electronics unit, in particular a function of the thermostat element. By means of the embodiment according to the invention, a convenient regulation of a temperature, in particular a room temperature and/or water temperature, can advantageously be implemented. A high level of user convenience can advantageously be achieved, in particular by a temperature regulation which is convenient and simple to operate.

Moreover, it is proposed that the storage device comprise at least one energy storage unit, in particular at least one accumulator, for storing electrical energy to supply the electronics unit. The energy storage unit is preferably arranged on the storage element and/or on the main body element. The energy storage unit is preferably at least partially integrated into the storage element and/or into the main body element, in particular replaceably. However, it is also conceivable that the energy storage unit is arranged in the receptacle recess and is arranged on a circuit board of the electronics unit. A wireless operation of the electronics unit can advantageously be implemented by means of the embodiment according to the invention. An arrangement of the storage device in a wet room, in particular in a shower stall, which is independent of a power line, can advantageously be implemented. A high level of user convenience can advantageously be achieved.

The storage device according to the invention is not to be restricted in this case to the above-described application and embodiment. In particular, the storage device according to the invention can comprise a number differing from a number mentioned herein of individual elements, components, and units to fulfill a functionality described herein. Moreover, in the value ranges specified in this disclosure, values lying within the mentioned limits are also to be considered to be disclosed and arbitrarily usable.

### DRAWINGS

Further advantages result from the following description of the drawings. Exemplary embodiments of the invention are illustrated in the drawings. The drawings, the description, and the claims contain numerous features in combination. A person skilled in the art will expediently also consider the features individually and combine them to form reasonable further combinations.

In the figures:

FIG. 1 shows a storage device according to the invention having an inspection element, which is arranged on a storage element of the storage device according to the invention, of an inspection unit of the storage device according to the invention in a schematic illustration,

FIG. 2 shows the storage device according to the invention having the inspection element located in an open state in a schematic illustration,

FIG. 3 shows an alternative storage device according to the invention having an inspection element, which is arranged on a main body element of a fastening unit of the storage device according to the invention, of an inspection unit of the storage device according to the invention in a schematic illustration, and

FIG. 4 shows a further alternative storage device according to the invention having an input and/or output element, which is movably mounted on a storage element and/or on a fastening unit of the storage device according to the invention, of an electronics unit of the storage device according to the invention in a schematic illustration.

### DESCRIPTION OF THE EXEMPLARY EMBODIMENTS

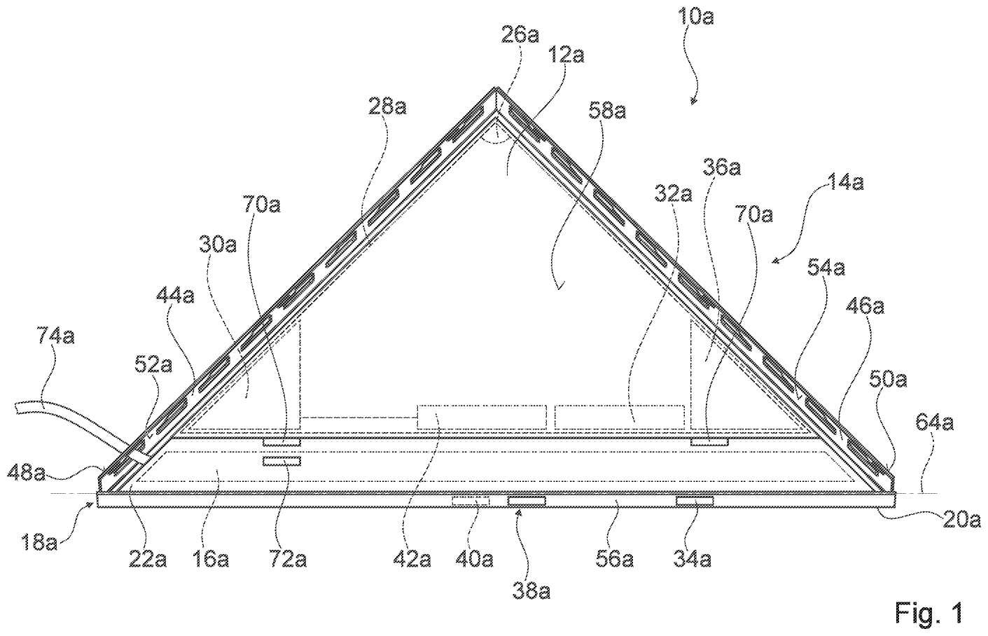

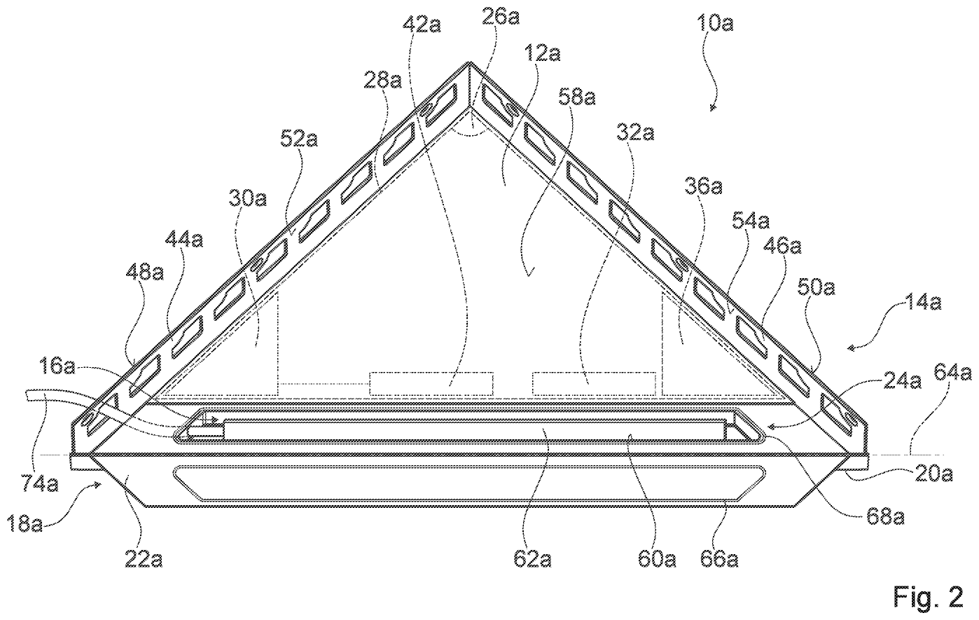

FIG. 1 shows a storage device 10a, in particular a bath and/or shower storage device. The storage device 10a is preferably provided to be arranged on a wall (not shown in greater detail here), in particular a tiled room wall. However, it is also conceivable that the storage device 10a is provided to be arranged on a furniture wall or the like. The storage device 10a is preferably provided to be arranged in a manner already known to a person skilled in the art from DE 10 2012 015 574 A1 on the wall, in particular below a wall covering, for example, tiles. The storage device 10a preferably comprises at least one fastening unit 14a for an arrangement on the wall. The fastening unit 14a preferably comprises at least one wall fastening element 44a, 46a for fastening of the fastening unit 14a on the wall, in particular the tiled room wall. The wall fastening element 44a, 46a preferably comprises at least one wall contact surface 48a, 50a, by means of which the wall fastening element 44a, 46a can be arranged on the wall, in particular on a raw wall, which is preferably untiled. The wall contact surface 48a, 50a is preferably provided to be fastened by means of a tile adhesive and/or a fastening element, for example, by means of a screw, by means of a nail, or the like on the wall, in particular on the raw wall. The wall fastening element 44a, 46a preferably comprises at least one wall covering contact surface 52a, 54a for contact on a wall covering (not shown in greater detail here), in particular on a tile. The wall covering, in particular the tile, is preferably fixable by means of a tile adhesive on the wall covering contact surface 52a, 54a. The wall covering contact surface 52a, 54a is preferably on a side of the wall fastening element 44a, 46a facing away from the wall contact surface 48a, 50a. In a state of the storage device 10a arranged on the wall by means of the fastening unit 14a, the wall fastening element 44a, 46a is preferably arranged between the wall covering and the raw wall, in particular viewed along a direction running at least essentially perpendicular to a main extension plane of the wall fastening element 44a, 46a. In the embodiment of the storage device 10a shown in FIGS. 1 and 2, the fastening unit 14a comprises at least two wall fastening elements 44a, 46a. However, it is also conceivable that the fastening unit 14a has a number of wall fastening elements 44a, 46a differing from two. In the embodiment of the storage device 10a shown in FIGS. 1 and 2, the storage device 10a and/or the fastening unit 14a has a polygonal base shape. The storage device 10a and/or the fastening unit 14a preferably has a triangular base shape in the embodiment of the storage device 10a shown in FIGS. 1 and 2. The wall fastening elements 44a, 46a are arranged on legs of the triangular base shape of the storage device 10a and/or the fastening unit 14a. The main extension plane of the wall fastening elements 44a, 46a runs in each case at least essentially perpendicular to a footprint of the storage device 10a and/or of the fastening unit 14a.

The storage device 10a comprises at least one storage element 12a and at least the fastening unit 14a for fastening of the storage element 12a on the wall, in particular on the tiled room wall. The storage element 12a is preferably arranged on a main body element 20a of the fastening unit 14a, in particular fixed thereon. The wall fastening elements 44a, 46a, the main body element 20a, and at least one peripheral web 56a preferably together form a receptacle for the storage element 12a. The peripheral web 56a and/or the wall fastening elements 44a, 46a preferably extend at least essentially perpendicular to a storage surface 58a of the storage element 12a. The wall fastening elements 44a, 46a, the main body element 20a, and the peripheral web 56a are integrally formed with one another.

The storage device 10a comprises at least one electronics unit 16a at least partially arranged on the storage element 12a, in particular an illumination unit and/or an entertainment electronics unit. The electronics unit 16a is preferably at least partially, in particular at least in large part, integrated into the storage device 10a, in particular into the storage element 12a. The storage element 12a and/or the main body element 20a of the fastening unit 14a preferably comprises at least one receptacle recess 60a for at least partially accommodating the electronics unit 16a (cf. FIG. 2). The electronics unit 16a is preferably arranged at least in large part in the receptacle recess 60a. The electronics unit 16a is preferably designed as an illumination unit and/or as an entertainment electronics unit. The electronics unit 16a can be designed as an LED unit, a loudspeaker unit, a display unit, an induction charging unit, an electronic operating unit, a projection unit, a sensor unit, an energy conversion unit, a camera unit, a microphone unit, and/or as another electronics unit which appears reasonable to a person skilled in the art.

The electronics unit 16a, in particular if the electronics unit 16a is embodied as an illumination unit, preferably comprises at least one illumination element 62a, in particular at least one LED, which is arranged on the storage element 12a and/or on the fastening unit 14a. The illumination element 62a is preferably arranged at least partially, in particular completely, in the receptacle recess 60a. The electronics unit 16a, in particular if the electronics unit 16a is embodied as an illumination unit, particularly preferably comprises a plurality of illumination elements 62a, in particular LEDs, which are arranged on the storage element 12a and/or on the fastening unit 14a, in particular are arranged in the receptacle recess 60a.

The storage device 10a comprises at least one inspection unit 18a, which comprises at least one inspection element 22a arranged on the main body element 20a of the fastening unit 14a and/or on the storage element 12a (cf. FIGS. 1 and 2), in particular a removably and/or movably mounted inspection element 22a. In the embodiment of the storage device 10a illustrated in FIGS. 1 and 2, the inspection element 22a is mounted movably, in particular pivotably, on the storage element 12a and/or on the fastening unit 14a, in particular on the peripheral web 56a. The inspection element 22a is preferably designed as an inspection flap. In FIG. 1, the inspection element 22a is shown in a closed state.

In FIG. 2, the inspection element 22a is shown in an open state. A movement axis 64a, in particular a pivot axis, of the inspection element 22a preferably runs at least essentially in parallel to the storage surface 58a. However, it is also conceivable that the movement axis 64a of the inspection element 22a runs along another direction which appears reasonable to a person skilled in the art. The inspection element 22a is preferably arranged on the storage surface 58a. In particular, the inspection element 22a forms a part of the storage surface 58a. The inspection element 22a is preferably arranged on the storage element 12a on a side of the storage element 12a facing away from the main body element 20a, in particular in a closed state of the inspection element 22a. The inspection unit 18a preferably comprises at least one, in particular movably mounted fixing element 70a for securing the inspection element 22a against a movement in relation to the storage element 12a and/or the main body element 20a. The fixing element 70a is preferably designed as a closure. The fixing element 70a can be designed as a movably mounted rotating lever, as a knee joint closure, as a screw, as a catch closure, or as another closure which appears reasonable to a person skilled in the art.

The storage device 10a comprises at least one seal unit 24a, which is provided to arrange the inspection element 22a in a sealed manner on the main body element 20a and/or on the storage element 12a, in particular according to a protection class greater than IPS1 according to DIN EN 60529 (cf. FIG. 2). The seal unit 24a comprises at least one seal element 66a, 68a arranged on the main body element 20a and/or on the storage element 12a. The seal element 66a, 68a is preferably arranged between the inspection element 22a and the main body element 20a and/or the storage element 12a. The seal element 66a, 68a preferably at least partially, in particular completely, encloses the receptacle recess 60a. The seal element 66a, 68a preferably abuts the main body element 20a and/or the storage element 12a with at least one seal surface. The seal element 66a, 68a preferably abuts the inspection element 22a with at least one further seal surface, in particular in a closed state of the inspection element 22a. The seal unit 24a preferably comprises at least two seal elements 66a, 68a. At least one of the seal elements 66a, 68a is preferably arranged on the main body element 20a and/or the storage element 12a. One of the seal elements 66a, 68a is preferably arranged on the inspection element 22a. However, it is also conceivable that the seal unit 24a comprises a number of seal elements 66a. 68a differing from two.

The storage device 10a comprises at least one, in particular wireless communication unit 26a, which is provided to exchange electronic data with an external unit (not shown in greater detail here), which are processable by the electronics unit 16a and/or are provided for control and/or regulation of the electronics unit 16a. The communication unit 26a can be designed as a Bluetooth unit, an NFC unit, an infrared unit, a radio unit, in particular a WLAN unit, and/or as another, in particular wireless communication unit which appears reasonable to a person skilled in the art. The external unit can be designed as a remote control, in particular for control and/or regulation of the electronics unit 16a, for example, for control and/or regulation of a color of the electronics unit 16a designed as an illumination unit, for control and/or regulation of a brightness of the electronics unit 16a designed as an illumination unit, for control and/or regulation of a volume of the electronics unit 16a designed as an entertainment electronics unit, for an intensity of a display of the electronics unit 16a designed as an entertainment electronics unit, for control and/or regulation of a temperature of the electronics unit 16a designed as a thermostat unit, or the like.

The electronics unit 16a comprises at least one, in particular wired energy and/or communication interface 34a for transfer of electrical energy and/or electronic data. The energy and/or communication interface 34a is preferably designed as a USB interface. However, it is also conceivable that the energy and/or communication interface 34a comprises another embodiment which appears reasonable to a person skilled in the art. The energy and/or communication interface 34a is preferably arranged at least partially on an outer side, which is accessible, in particular in a state of the storage device 10a arranged on the wall, for example, in the region of the peripheral web 56a, on the storage surface 58a, on a side of the main body element 20a facing away from the storage surface 58a. The seal unit 24a preferably comprises at least one closure element (not shown in greater detail here), which is provided to close the energy and/or communication interface 34a in a sealed manner.

Furthermore, the electronics unit 16a preferably comprises at least one, in particular acoustic and/or optical input and/or output element 28a, which is arranged on the main body element 20a and/or on the storage element 12a, wherein the input and/or output element 28a can be controlled and/or regulated in dependence on electronic data transferred by means of the communication unit 26a. The input and/or output element 28a can be designed as a display, in particular as a touch display, and/or as a loudspeaker. If the input and/or output element 28a is embodied as a display, the input and/or output element 28a is preferably at least partially integrated into the storage element 12a. In particular, the input and/or output element 28a at least partially forms the storage surface 58a of the storage element 12a. However, it is also conceivable that the input and/or output element 28a is arranged at another position on the storage device 10a which appears reasonable to a person skilled in the art, for example, on the inspection element 22a. If the input and/or output element 28a is arranged on the inspection element 22a, the input and/or output element 28a is preferably movably mounted together with the inspection element 22a in relation to the storage element 12a and/or to the main body element 20a.

The electronics unit 16a comprises at least one, in particular touch-sensitive operating element 32a arranged on the main body element 20a and/or on the storage element 12a for an input of operating commands. However, it is also conceivable that alternatively the in particular touch-sensitive operating element 32a is arranged on the inspection element 22a, or that in addition one, in particular touch-sensitive further operating element 72a for an input of operating commands is arranged on the inspection element 22a. The operating element 32a and/or the further operating element 72a is preferably designed as a touch operating element. However, it is also conceivable that the operating element 32a and/or the further operating element 72a has another embodiment which appears reasonable to a person skilled in the art. It is also conceivable that the operating element 32a and/or the further operating element 72a is integrally formed with the input and/or output element 28a designed as a touch display.

The storage device 10a comprises at least one energy conversion unit 30a, in particular an energy harvesting unit, which is provided to convert mechanical energy and/or thermal energy into electrical energy for operation of the electronics unit 16a. The energy conversion unit 30a is preferably arranged on the storage element 12a and/or on the main body element 20a. The energy conversion unit 30a is preferably arranged on a side of the storage element 12a facing away from the main body element 20a, in particular on the storage surface 58a. The storage device 10a comprises at least one energy storage unit 42a, in particular an accumulator, for storing electrical energy for supply of the electronics unit 16a. The energy conversion unit 30a is preferably electrically connected to the energy storage unit 42a. The energy storage unit 42a can be arranged in the main body element 20a or in the storage element 12a, in particular in the receptacle recess 60a. It is conceivable that the storage device 10a and/or the electronics unit 16a comprises, alternatively or additionally to the energy storage unit 42a, an energy supply line 74a, which is provided for a connection to a power grid, in particular to supply at least the electronics unit 16a with electrical energy.

The electronics unit 16a comprises at least one induction unit 36a, which is provided for an inductive transfer of electrical energy. The induction unit 36a is preferably arranged on the storage element 12a, in particular in close range to the storage surface 58a of the storage element 12a, and/or on the main body element 20a. The induction unit 36a preferably comprises at least one induction coil element (not shown in greater detail here), which is provided for a wireless transfer of electrical energy in a manner already known to a person skilled in the art.

The electronics unit 16a comprises at least one projection unit 38a, which is provided to project items of information on an object spaced apart from the projection unit 38a, in particular a room wall or a water jet. The projection unit 38a is preferably arranged on the storage element 12a and/or on the main body element 20a. At least one output lens element (not shown in greater detail here) of the projection unit 38a is preferably arranged in an outer side of the storage element 12a and/or of the main body element 20a, in particular to enable an emission of a projection beam, in particular a light beam and/or laser beam.

The electronics unit 16a comprises at least one thermostat element 40a for regulating a temperature of a water jet and/or a room temperature, in particular as a result of a wireless transfer of electronic data to an external heating device (not shown in greater detail here). The thermostat element 40a preferably has a data connection to the communication unit 26a, in particular to implement a wireless transfer of electronic data to the external heating device. An operator can preferably input a desired temperature, for example, via the input and/or output element 28a designed as a touch display, via the operating element 32a, and/or via the further operating element 72a, to which the thermostat element 40a regulates a temperature of a water jet and/or a room temperature as a result of a wireless transfer of electronic data to the external heating device.

Further functions of the electronics unit 16a and/or arrangements of the electronics unit 16a on the storage element 12a and/or the main body element 20a which appear reasonable to a person skilled in the art are also conceivable.

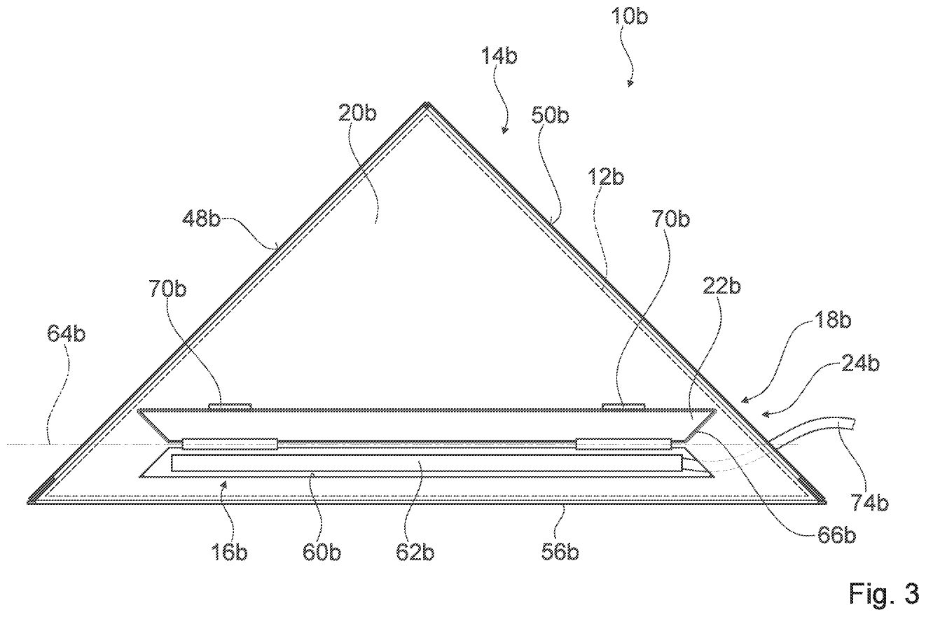

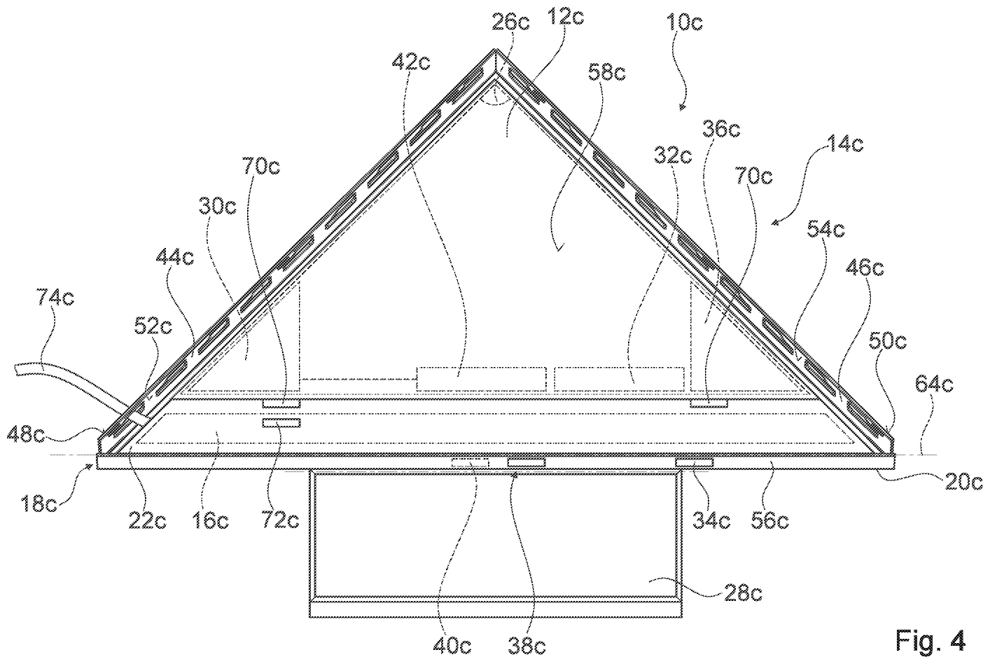

Further exemplary embodiments of the invention are shown in FIGS. 3 and 4. The following descriptions and the drawings are essentially restricted to the differences between the exemplary embodiments, wherein reference can also be made in principle to the drawings and/or the description of the other exemplary embodiments, in particular of FIGS. 1 and 2, with respect to identically identified components, in particular with respect to components having identical reference signs. To differentiate the exemplary embodiments, the letter a is appended to the reference signs of the exemplary embodiment in FIGS. 1 and 2. The letter a is replaced by the letters b and c in the exemplary embodiments of FIGS. 3 and 4.

FIG. 3 shows an alternative storage device 10b, which is designed in particular as a bath and/or shower storage device. The storage device 10b comprises at least one storage element 12b and at least one fastening unit 14b for fastening of the storage element 12b on a wall, in particular a tiled room wall. The storage device 10b comprises at least one electronics unit 16b at least partially arranged on the storage element 12b, in particular an illumination unit and/or an entertainment electronics unit. In contrast to the storage device 10a described in the description of FIGS. 1 and 2, the storage device 10b illustrated in FIG. 3 comprises at least one inspection element 22b, which is arranged on a main body element 20b of the fastening unit 14b of the storage device 10b, of an inspection unit 18b of the storage device 10b. The inspection element 22b is mounted movably, in particular pivotably, on the main body element 20b and/or on a peripheral web 56b of the fastening unit 14b. The inspection element 22b is preferably designed as an inspection flap. A movement axis 64b, in particular a pivot axis, of the inspection element 22b preferably runs at least essentially in parallel to a storage surface 58b of the storage element 12b. However, it is also conceivable that the movement axis 64b of the inspection element 22b runs along another direction which appears reasonable to a person skilled in the art. The inspection element 22b is preferably arranged on a side of the main body element 20b facing away from the storage surface 58b on the main body element 20b and/or on the peripheral web 56b. In addition, it is conceivable that the inspection unit 18b comprises a further inspection element (not shown in greater detail here), which, in particular similarly to the inspection element 22a described in the description of FIGS. 1 and 2, is mounted movably, in particular pivotably, on the storage element 12b and/or on the fastening unit 14b, in particular on the peripheral web 56b. With respect to further features of the storage device 10b shown in FIG. 3, reference can be made to the description of FIGS. 1 and 2, which is to be read similarly to FIG. 3.

FIG. 4 shows a further alternative storage device 10c, which is designed in particular as a bath and/or shower storage device. The storage device 10c comprises at least one storage element 12c and at least one fastening unit 14c for fastening of the storage element 12c on a wall, in particular a tiled room wall. The storage device 10c comprises at least one electronics unit 16c arranged at least partially on the storage element 12c, in particular an illumination unit and/or an entertainment electronics unit. In contrast to the storage device 10a described in the description of FIGS. 1 and 2, the storage device 10c shown in FIG. 4 comprises an input and/or output element 28c of the electronics unit 16c mounted movably, in particular pivotably, on a main body element 20c of the fastening unit 14c and/or on a peripheral web 56c of the fastening unit 14c. The movably mounted input and/or output element 28c is preferably designed as a touch display. A movement axis of the input and/or output element 28c preferably runs at least essentially in parallel to a storage surface 58c of the storage element 12c. The input and/or output element 28c is preferably mounted movably on the fastening unit 14c on a side of the main body element 20c and/or the peripheral web 56c facing away from the storage surface 58c of the storage element 12c. The input and/or output element 28c can preferably be applied in a pivoted-in state to the main body element 20c, in particular to the side of the main body element 20c facing away from the storage surface 58c of the storage element 12c. With respect to further features of the storage device 10c shown in FIG. 4, reference can be made to the description of FIGS. 1 and 2, which is to be read similarly to FIG. 4.

### LIST OF REFERENCE SIGNS

10 storage device
12 storage element
14 fastening unit
16 electronics unit
18 inspection unit
20 main body element
22 inspection element
24 seal unit
26 communication unit
28 input and/or output element
30 energy conversion unit
32 operating element
34 energy and/or communication interface
36 induction unit
38 projection unit
40 thermostat element
42 energy storage unit
44 wall fastening element
46 wall fastening element
48 wall contact surface
50 wall contact surface
52 wall covering contact surface
54 wall covering contact surface
56 peripheral web
58 storage surface
60 receptacle recess
62 illumination element
64 movement axis
66 seal element
68 seal element
70 fixing element
72 operating element
74 energy supply line

1. A storage device, comprising:
at least one storage element,
at least one fastening unit for fastening the storage element on a wall,
at least one electronics unit, which is at least partially arranged on the storage element, and is embodied as an illumination unit and/or an entertainment electronics unit, and at least one inspection unit, which comprises at least one inspection element removably or movably mounted on a main body element of the fastening unit or on the storage element.

2. The storage device according to claim 1, further comprising at least one seal unit, which is configured to arrange the inspection element in a sealed manner on the main body element or on the storage element.

3. The storage device according to claim 1, further comprising at least one communication unit, which is configured to exchange electronic data with an external unit, which are processable by the electronics unit or are provided for control of the electronics unit.

4. The storage device according to claim 3, wherein the electronics unit comprises at least one input or output element, which is configured to acoustically or optically input or output information and is arranged on the main body element or on the storage element, wherein the input or output element is configured to be controlled in dependence on electronic data transferred by means of the communication unit.

5. The storage device according to claim 1, wherein the electronics unit comprises at least one input or output element, which is configured to acoustically or optically input or output information and is movably mounted on the main body element or on the storage element.

6. The storage device according to claim 1, further comprising at least one energy conversion unit, which is configured to convert mechanical energy or thermal energy into electrical energy for operation of the electronics unit.

7. The storage device according to claim 1, wherein the electronics unit comprises at least one operating element, which is arranged on the main body element or on the storage element, for inputting operating commands.

8. The storage device according to claim 1, wherein the electronics unit comprises at least one interface for transferring electrical energy or electronic data.

9. The storage device according to claim 1, wherein the electronics unit comprises at least one induction unit, which is configured to inductively transfer electrical energy.

10. The storage device according to claim 1, wherein the electronics unit comprises at least one projection unit, which is configured to project items of information on an object spaced apart from the projection unit.

11. The storage device according to claim 1, wherein the electronics unit comprises at least one thermostat element for regulating a temperature of a water jet or a room temperature.

12. The storage device according to claim 1, further comprising at least one energy storage unit for storing electrical energy to supply the electronics unit.

13. The storage device according to claim 1, embodied as a bath storage device or a shower storage device.
